(19) United States
(12) Patent Application Publication
(10) Pub. No.: US 2013/0090836 A1
(43) Pub. Date: Apr. 11, 2013

(54) SYSTEM AND METHOD FOR THROTTLE POSITION SENSOR ELIMINATION

(71) Applicants: Thomas Raymond Culbertson, Livonia, MI (US); Santhosh Arasan, Chennai (IN); SrinivasaRamanujam Gopalakrishnan, Chennai (IN)

(72) Inventors: Thomas Raymond Culbertson, Livonia, MI (US); Santhosh Arasan, Chennai (IN); SrinivasaRamanujam Gopalakrishnan, Chennai (IN)

(73) Assignee: VISTEON GLOBAL TECHNOLOGIES, INC., Van Buren Twp., MI (US)

(21) Appl. No.: 13/267,199

(22) Filed: Oct. 6, 2011

(51) Int. Cl. F02D 41/30

(52) U.S. Cl. 701/104

(57) ABSTRACT

A control system for an engine having at least one manifold, a throttle, and a crank wheel includes a pressure sensor to measure a pressure in the at least one manifold and generate a pressure signal representing the pressure measured, a revolution sensor to measure a rate of rotation of the crank wheel of the engine and generate a rotation signal representing the rate of rotation measured, a processor in communication with each of the pressure sensor and the revolution sensor to receive the pressure signal and the rotation signal, analyze the pressure signal and the rotation signal based upon an instruction set to estimate a position of the throttle, and generate a control signal in response to the analysis of the pressure signal and the rotation signal; and an engine system to receive the control signal to control a function of the engine system.

### FIELD OF THE INVENTION

The present invention relates generally to a system and method for controlling an engine system. In particular, the invention is directed to a system and a method for controlling an engine system without the use of a throttle position sensor.

### BACKGROUND OF THE INVENTION

Motorcycle engine control systems are too expensive for emerging markets such as India, for example. Conventional engine control systems include multiple feedback sensors including a throttle position sensor to measure throttle plate opening. Typically, a feedback measurement received from the throttle position sensor is used in concert with a feedback from a manifold pressure sensor to control a fuel injection process.

It would be desirable to develop a system and a method for controlling an engine system without the required use of a throttle position sensor.

### SUMMARY OF THE INVENTION

Concordant and consistent with the present invention, a system and a method for controlling an engine system without the required use of a throttle position sensor, has surprisingly been discovered.

In one embodiment, a control system for an engine having at least one manifold, a throttle, and a crank wheel, the system comprises: a pressure sensor to measure a pressure in the at least one manifold and generate a pressure signal representing the pressure measured; a revolution sensor to measure a rate of rotation of the crank wheel of the engine and generate a rotation signal representing the rate of rotation measured; a processor in communication with each of the pressure sensor and the revolution sensor to receive the pressure signal and the rotation signal, analyze the pressure signal and the rotation signal based upon an instruction set to estimate a position of the throttle, and generate a control signal in response to the analysis of the pressure signal and the rotation signal; and an engine system in communication with the processor to receive the control signal therefrom, the engine system responsive to the control signal to control a function of the engine system.

The invention also provides methods for controlling an engine.

One method comprises the steps of:
a) measuring a pressure in at least one manifold of the engine;
b) measuring a rate of rotation of a crank wheel of the engine;
c) determining an estimated position of a throttle of the engine based upon the pressure measured in the at least one manifold and the rate of rotation of the crank wheel measured; and
d) controlling an engine system based upon the estimated position of the throttle.

Another method comprises the steps of:
a) measuring a first pressure in at least one manifold of the engine at a first rotational position of a crank wheel of the engine;
b) measuring a first pressure in the at least one manifold of the engine at a second rotational position of the crank wheel;
c) measuring a second pressure in the at least one manifold of the engine at the second rotational position of the crank wheel;
d) determining a delta pressure measured value between the second pressure measured at the second rotational position of the crank wheel and the first pressure measured at the second rotational position of the crank wheel; and
e) controlling the engine system based upon the delta pressure measured value.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic diagram of an engine control system according to an embodiment of the present invention;

FIG. 2 is a schematic flow diagram of a method for controlling an engine system according to an embodiment of the present invention;

FIG. 3 is a schematic flow diagram of a method for controlling an engine system according to another embodiment of the present invention;

FIG. 4 is a graphical representation of a simulation of the method for controlling the engine system described in FIG. 3 during a time interval; and

FIG. 5 is a graphical representation of a simulation of an operation of the an engine during an interval, showing a plurality of throttle position plots based upon a manifold pressure at a particular rotational position of a crank wheel of the engine.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

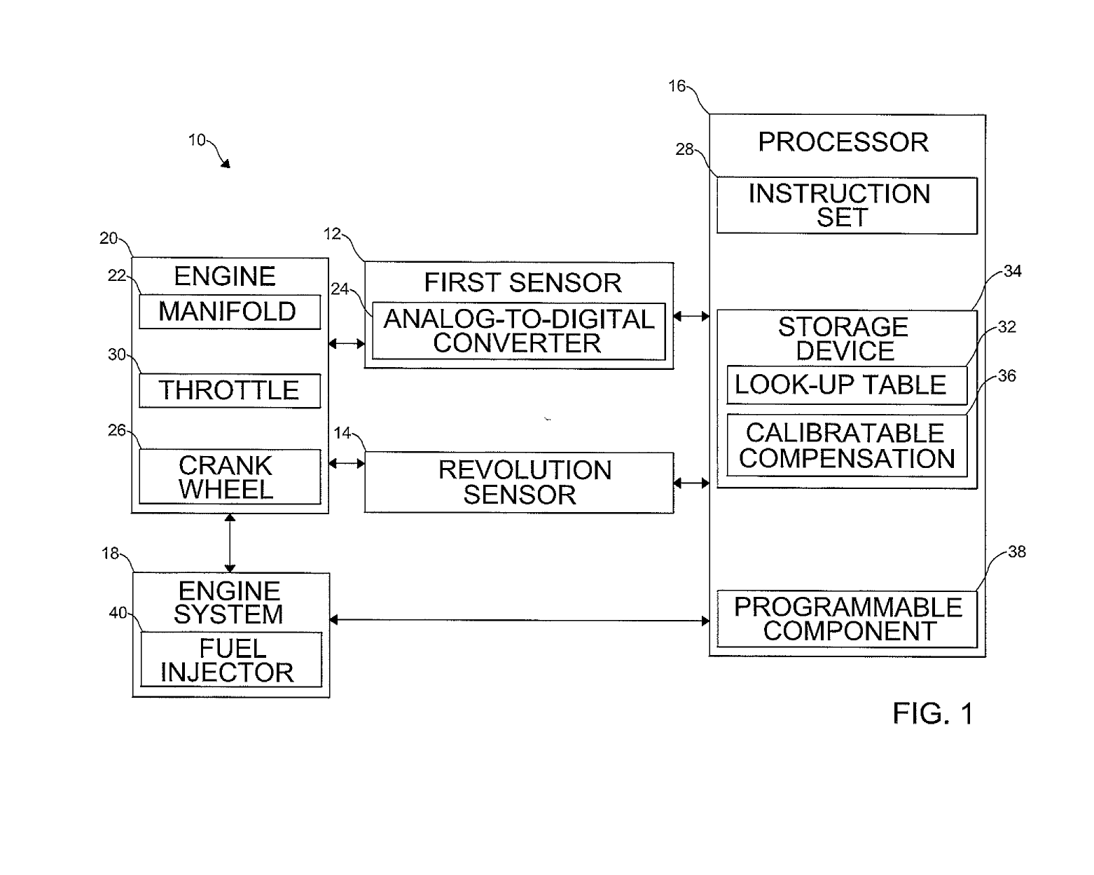

FIG. 1 illustrates a control system 10 for an internal combustion engine according to an embodiment of the present invention. As shown, the system 10 includes a first sensor 12, a revolution sensor 14, a processor 16, and an engine system 18. The control system 10 can include any number of components, as desired. The control system 10 can be integrated in any vehicle such as a motorcycle having a fuel injected 4-stroke engine 20, for example.

The first sensor 12 is typically a pressure sensor positioned to measure a manifold absolute pressure (MAP) in a manifold of an internal combustion engine. As a non-limiting example, the first sensor 12 is disposed in an intake manifold 22 of the fuel injected engine 20. The first sensor 12 provides instantaneous manifold pressure information to the processor 16 in the form of a pressure sensor signal. However, it is understood that other pressure sensors can be used to measure absolute and differential pressure in a particular manifold of any type of engine. It is further understood that any number of the pressure sensors 12 can be used.

In certain embodiments, an analog-to-digital converter 24 (ADC) is in data communication with the first sensor 12 and the processor 16 to receive an analog signal (e.g. approximately 0-5 volts in range) from the first sensor 12, convert the analog signal into a digital signal, and transmit the digital signal to the processor 16 for conversion into a quantitative absolute pressure value (e.g. in units of kPa). As a non-limiting example, the conversion of digital signal by the processor 16 is based upon a pre-defined information stored in a look-up table.

The revolution sensor 14 is typically a variable reluctance processor adapted to measure at least one of a rotational position and a rate of rotation of a rotating body. However, other revolution/rotation sensors can be used. In certain embodiments, the revolution sensor 14 is disposed to measure the revolutions per minute (rpm) of a thirty-six tooth minus one (36−1) crank wheel 26 of the engine 20. Each tooth of the crank wheel 26 corresponds to 10° of rotation of the crank wheel 26 (10° of crank angle). It is understood that the term “crank angle” used hereinafter refers to an angle of rotation of the crank wheel 26 measured from a position in which a piston of the engine 20 is at its highest point known as top dead center (TDC) during a compression phase thereof. For example, at 360° of crank angle of the crank wheel 26 the piston of the engine 20 is at TDC during an exhaust phase thereof. Accordingly, the entire crank wheel 26 has 720° of crank angle per engine cycle. As a non-limiting example, the revolution sensor 14 outputs a waveform representing the rate of rotation of the crank wheel 26. As a further non-limiting example, the waveform is converted into a digital square wave and a time period of the square wave is converted into a quantitative rpm value of the crank wheel 26. It is understood that the revolution sensor 14 can be adapted to measure rotation of any apparatus or component of the engine 20.

The processor 16 may be any device or system adapted to receive an input signal (e.g. at least one of the signals received from the sensors 12, 14), analyze the input signal, and configure the engine system 18 in response to the analysis of the input signal. In certain embodiments, the processor 16 is a micro-computer. As a non-limiting example, the processor 16 can be a part of a conventional engine control unit (ECU). In the embodiment shown, the processor 16 receives the input signal from at least one of the sensors 12, 14 and a user-provided input.

As shown, the processor 16 analyzes the input signal based upon an instruction set 28. The instruction set 28, which may be embodied within any computer readable medium, includes processor executable instructions for configuring the processor 16 to perform a variety of tasks. The processor 16 may execute a variety of functions such as controlling the operation of the sensors 12, 14 and the engine system 18, for example. It is understood that various algorithms and software can be used to analyze the input signal.

As a non-limiting example, the instruction set 28 includes a suite of mathematical formulas to calculate an inferred or estimated position of a throttle 30 based upon a pressure data (e.g. inferred or directly measured) and the rate of rotation of the crank wheel 26 (e.g. ic_thr_est=icm_thr_est (an_rpm, an_atdc_map_std), where: an_atdc_map_std an_atdc_map/lhm_bap_compensation (normalized to STP) and icm_thr_est is the estimated throttle position). In certain embodiments, the estimated position of the throttle 30 is determined from a look-up table 32 based upon the normalized absolute manifold pressure and the rate of rotation of the crank wheel 26. As a further non-limiting example, the instruction set 28 includes mathematical formulas for estimating a throttle angle during an intake valve opening (IVO) task (e.g. tf_thr_est=tfm_thr_est(an_rpm, tf_ivo_map_std), where: tf_ivo_map_std=tf_ivo_map/lhm_bap_compensation; tf_ivo_map is the map reading during the IVO task; and tfm_thr_est is the estimated throttle position).

In certain embodiments, the processor 16 includes a storage device 34. The storage device 34 may be a single storage device or may be multiple storage devices. Furthermore, the storage device 34 may be a solid state storage system, a magnetic storage system, an optical storage system or any other suitable storage system or device. It is understood that the storage device 34 may be adapted to store the instruction set 28. Other data and information may be stored and cataloged in the storage device 34 such as the data collected by the sensors 12, 14 and the engine system 18, for example. In certain embodiments, the storage device 34 includes the look-up table 32 and a calibratable compensation factor 36 (e.g. lhm_bap_compensation, other compensation factors for a measured manifold pressure relative to a barometric pressure measurement or atmospheric pressure, or the like). It is understood that the storage device 34 can include any number of look-up tables that can be referenced by the processor 16 to perform various calculations such as converting a received digital signal into a quantitative value (e.g. the measured manifold pressure, the throttle position, the rate of rotation, etc.).

The processor 16 may further include a programmable component 38. It is understood that the programmable component 38 may be in communication with any other component of the control system 10 such as the sensors 12, 14 and the engine system 18, for example. In certain embodiments, the programmable component 38 is adapted to manage and control processing functions of the processor 16. Specifically, the programmable component 38 is adapted to modify the instruction set 28 and control the analysis of the input signal and information received by the processor 16. It is understood that the programmable component 38 may be adapted to manage and control the sensors 12, 14 and the engine system 18. It is further understood that the programmable component 38 may be adapted to store data and information on the storage device 34, and retrieve data and information from the storage device 34.

The engine system 18 can be any device or system adapted to interact with the engine 20 to affect an operation of the engine 20. As a non-limiting example, the engine system 18 can include a fuel injector 40 for injecting a fuel into the manifold 22 for a pre-determined time period (i.e. pulse width). The engine system 18 is in communication with the processor 16 to receive a control signal therefrom to control an operation of the engine system 18. As a further non-limiting example, an injection pulse width of the fuel injector 40 is responsive to the control signal received from the processor 16.

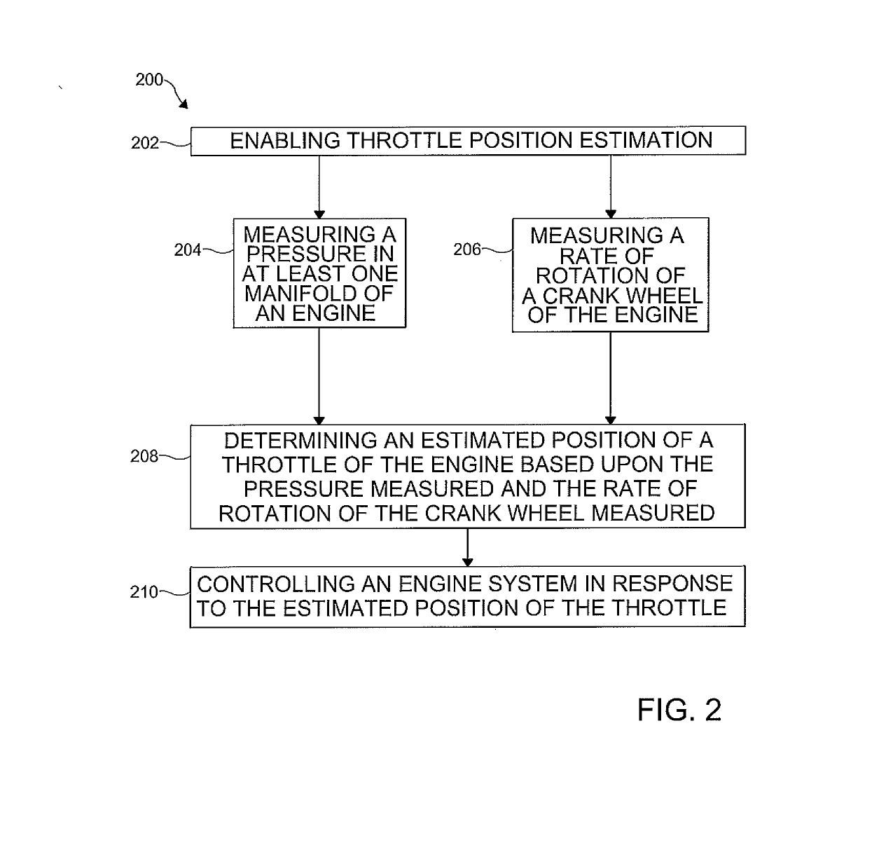

FIG. 2 illustrates a method 200 for controlling the engine system 18.

In step 202, a throttle position estimation is enabled, whereby a position of a plate of the throttle 30 can be estimated without a conventional throttle position sensor.

In step 204, the first sensor 12 measures a pressure in the manifold 22 at a predetermined rotational position of the crank wheel 26. In particular embodiments, the revolution sensor 14 senses when the crank wheel 26 is at the predetermined rotational position to initiate the measurement of the pressure in the manifold 22 of the engine 20. Substantially simultaneously in step 206, the revolution sensor 14 measures a rate of rotation of the crank wheel 26. In certain embodiments, each of the sensors 12, 14 cooperate with the processor 16 to provide a quantitative value representing the measured pressure in the manifold 22 and the rate of rotation of the crank wheel 26, respectively.

In step 208, the processor 16 receives a signal from each of the sensors 12, 14 and determines an estimated position of the throttle 30 of the engine 20 based upon the pressure measured and the rate of rotation of the crank wheel 26 measured. As a non-limiting example, the processor 16 estimates the position of the throttle 30 based upon the instruction set 28.

In step 210, the engine system 18 is controlled in response to the estimated position of the throttle 30. As a non-limiting example, the engine system 18 controls a fuel injection (e.g. an injection pulse rate) into the manifold 22 in response to the estimated position of the throttle 30. As a further non-limiting example, the engine system 18 controls a fuel mass to air mass ratio that is injected into the manifold 22 in response to the estimated position of the throttle 30.

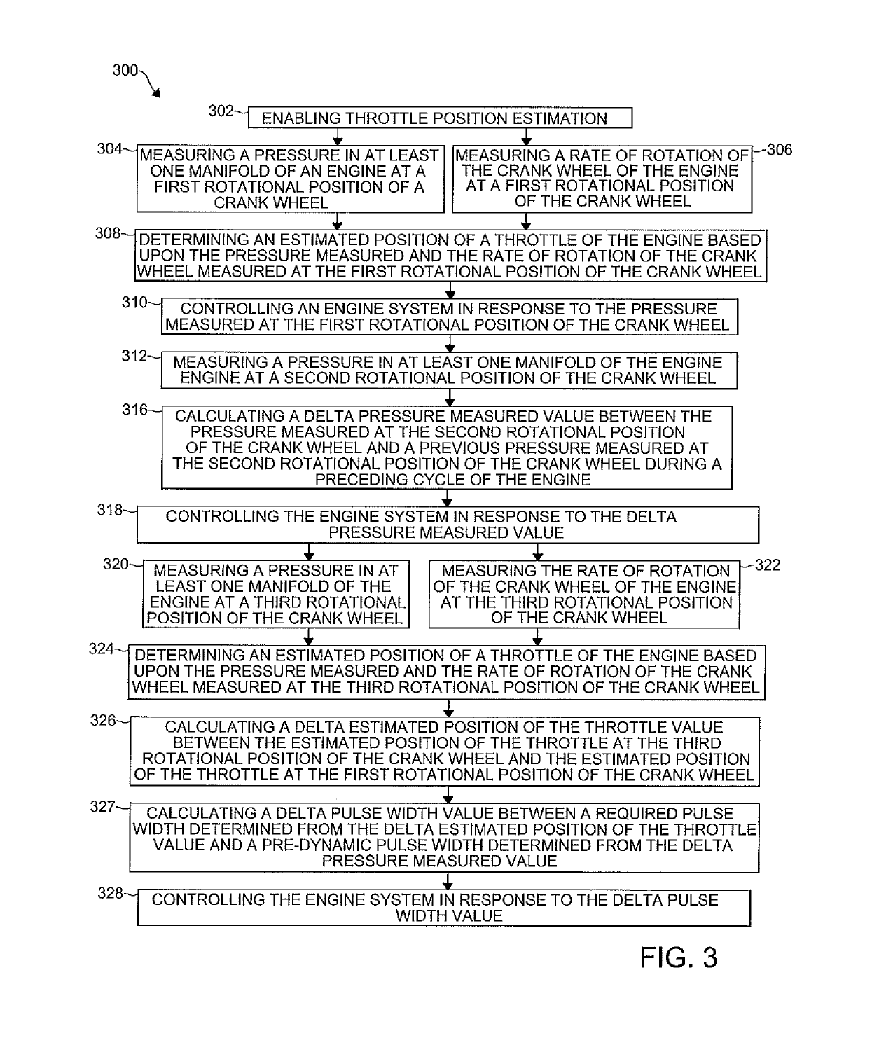

FIG. 3 illustrates a method 300 for controlling the engine system 18.

In step 302, a throttle position estimation is enabled, whereby a position of a plate of the throttle 30 can be estimated without a conventional throttle position sensor.

In step 304, the first sensor 12 measures a pressure in the manifold 22 of the engine 20 at a first rotational position of the crank wheel 26. In particular embodiments, the revolution sensor 14 senses when the crank wheel 26 is at the first rotational position to initiate the measurement of the pressure in the manifold 22 of the engine 20. Substantially simultaneously in step 306, the revolution sensor 14 measures a rate of rotation of the crank wheel 26. In certain embodiments, each of the sensors 12, 14 cooperate with the processor 16 to provide a quantitative value representing the pressure measured in the manifold 22 and the rate of rotation of the crank wheel 26, respectively, at the first rotational position of the crank wheel 26.

In step 308, the processor 16 receives a signal from each of the sensors 12, 14 and determines an estimated position of the throttle 30 of the engine 20 based upon the rate of rotation of the crank wheel 26 measured by the revolution sensor 14 and the pressure measured at the first rotational position of the crank wheel 26. As a non-limiting example, the processor 16 employs the use of the instruction set 28 to estimate the position of the throttle 30 at the first rotational position of the crank wheel 26. In step 310, the engine system 18 is controlled in response to the pressure measured at the first rotational position of the crank wheel 26. As a non-limiting example, the engine system 18 controls a fuel injection (e.g. an injection pulse rate) into the manifold 22 in response to the pressure measured at the first rotational position of the crank wheel 26. As a further non-limiting example, the engine system 18 controls a fuel mass to air mass ratio that is injected into the manifold 22 in response to the pressure measured at the first rotational position of the crank wheel 26. In certain embodiments, the pressure measured at the first rotational position of the crank wheel 26 is used to initiate a base pulse width to deliver a steady state fuel requirement.

In step 312, the first sensor 12 measures a pressure in the manifold 22 of the engine 20 at a second rotational position of the crank wheel 26. In particular embodiments, the revolution sensor 14 senses when the crank wheel 26 is at the second rotational position to initiate the measurement of the pressure in the manifold 22 of the engine 20. In certain embodiments, the sensor 12 cooperates with the processor 16 to provide a quantitative value representing the pressure measured in the manifold 22 at the second rotational position of the crank wheel 26.

In step 316, the processor 16 receives a signal from the sensor 12 and calculates a delta pressure value between the pressure measured at the second rotational position of the crank wheel 26 and a previous pressure measured at the second rotational position of the crank wheel 26 during a preceding cycle of the engine 20. In step 318, the engine system 18 is controlled in response to the delta pressure value between the pressure measured at the second rotational position of the crank wheel 26 and the previous pressure measured at the second rotational position of the crank wheel 26 during the preceding cycle of the engine 20. As a non-limiting example, the engine system 18 controls a fuel injection (e.g. an injection pulse rate) into the manifold 22 in response to the delta pressure value. As a further non-limiting example, the engine system 18 controls a fuel mass to air mass ratio that is injected into the manifold 22 in response to the delta pressure value. In certain embodiments, the delta pressure value is used to recognize a transient throttle 30 event and initiate a pre-dynamic pulse width to deliver a substantial amount of a fuel requirement.

In step 320, the first sensor 12 measures a pressure in the manifold 22 of the engine 20 at a third rotational position of the crank wheel 26. In particular embodiments, the revolution sensor 14 senses when the crank wheel 26 is at the third rotational position to initiate the measurement of the pressure in the manifold 22 of the engine 20. Substantially simultaneously in step 322, the revolution sensor 14 measures a rate of rotation of the crank wheel 26. In certain embodiments, each of the sensors 12, 14 cooperate with the processor 16 to provide a quantitative value representing the pressure measured in the manifold 22 and the rate of rotation of the crank wheel 26, respectively, at the third rotational position of the crank wheel 26.

In step 324, the processor 16 receives a signal from each of the sensors 12, 14 and determines an estimated position of the throttle 30 of the engine 20 based upon the rate of rotation of the crank wheel 26 measured by the revolution sensor 14 and the pressure measured at the third rotational position of the crank wheel 26. As a non-limiting example, the processor 16 employs the use of the instruction set 28 to estimate the position of the throttle 30 at the third rotational position of the crank wheel 26. In step 326, the processor 16 calculates a delta estimated position of the throttle 30 value between the estimated position of the throttle 30 at the third rotational position of the crank wheel 26 and the estimated position of the throttle 30 at the first rotational position of the crank wheel 26. In step 327, the processor 16 calculates a delta pulse width value between a required pulse width determined from the delta estimated position of the throttle 30 value and the pre-dynamic pulse width determined from the delta pressure value. In step 328, the engine system 18 is controlled in response to the delta pulse width value. As a non-limiting example, the engine system 18 controls a fuel injection (e.g. an injection pulse rate) into the manifold 22 in response to the delta pulse width value. As a further non-limiting example, the engine system 18 controls a fuel mass to air mass ratio that is injected into the manifold 22 in response to the delta pulse width value. In certain embodiments, the delta pulse width value is used to initiate a final dynamic pulse width to deliver a remainder amount of the fuel requirement.

It is understood that the steps for the method 300 as described hereinabove can be repeated as desired.

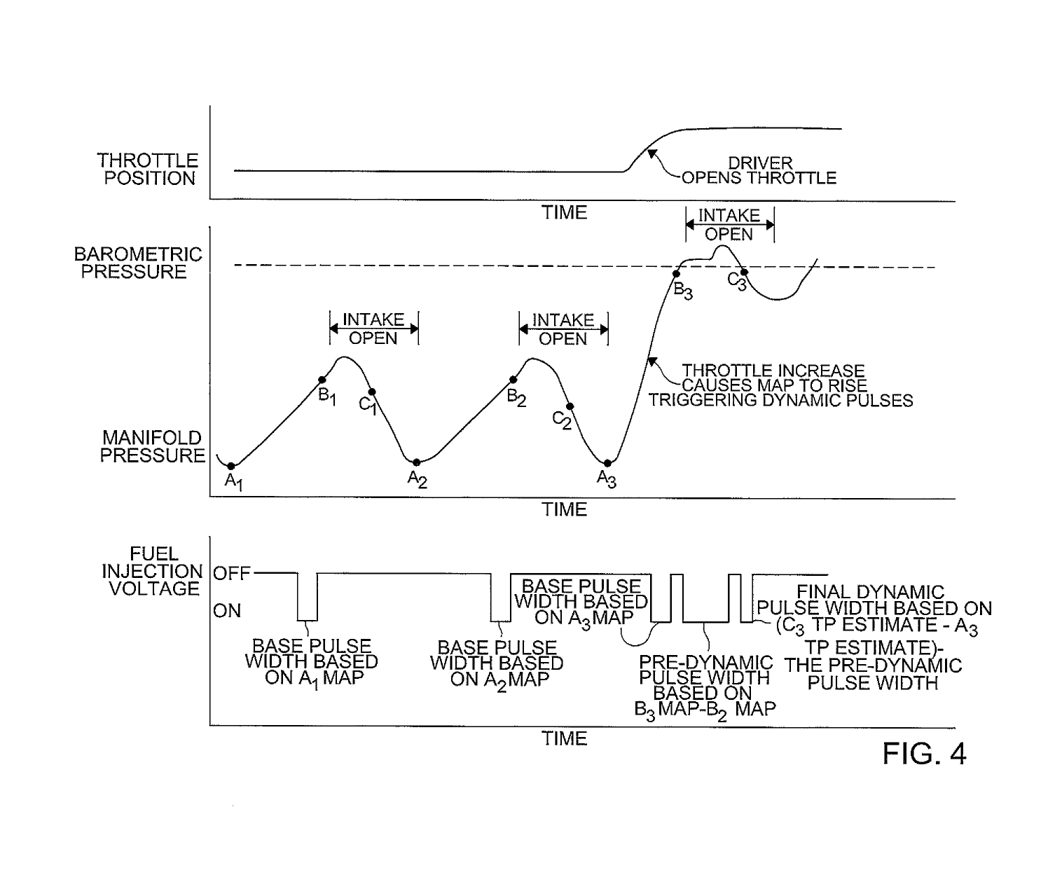

A non-limiting example of the method 300 is illustrated in FIG. 4. The first sensor 12 measures a pressure A₁ in the manifold 22 of the engine 20 at a first rotational position of the crank wheel 26. As shown, the pressure measured A₁ is sampled at the first rotational position of the crank wheel 26 which is substantially instantaneous with a close of an intake valve at about 450° to about 500° of crank angle of the crank wheel 26 during a first cycle of the engine 20. Substantially simultaneously, the revolution sensor 14 measures a rate of rotation of the crank wheel 26. The processor 16 receives a signal from each of the sensors 12, 14 and determines an estimated position A₁ TP ESTIMATE of the throttle 30 of the engine 20 based upon the rate of rotation of the crank wheel 26 measured by the revolution sensor 14 and the pressure measured A₁ at the first rotational position of the crank wheel 26. The engine system 18 is controlled in response to the pressure measured A₁ at the first rotational position of the crank wheel 26, whereby the pressure measured A₁ is used to initiate a base pulse width to deliver a steady state fuel requirement.

The first sensor 12 measures a pressure B₁ in the manifold 22 of the engine 20 at a second rotational position of the crank wheel 26. As shown, the pressure measured B₁ is sampled at the second rotational position of the crank wheel 26 prior to an opening of the intake valve at about 340° to about 380° of crank angle of the crank wheel 26 during a second cycle of the engine 20. The processor 16 receives a signal from the first sensor 12 and calculates a delta pressure value between the pressure measured B₁ at the second rotational position of the crank wheel 26 and a previous pressure measured (not shown) at the second rotational position of the crank wheel 26 during the first cycle of the engine 20. The engine system 18 is controlled in response to the delta pressure value between the pressure measured B₁ at the second rotational position of the crank wheel 26 and the previous pressure measured at the second rotational position of the crank wheel 26 during the first cycle of the engine 20. As shown, the delta pressure value did not recognize a transient throttle 30 event and a pre-dynamic pulse width was not initiated.

The first sensor 12 measures a pressure C₁ in the manifold 22 of the engine 20 at a third rotational position of the crank wheel 26. As shown, the pressure measured C₁ is sampled at the third rotational position of the crank wheel 26 during an opening of the intake valve at about 380° to about 420° of crank angle of the crank wheel 26 during the second cycle of the engine 20. Substantially simultaneously, the revolution sensor 14 measures a rate of rotation of the crank wheel 26. The processor 16 receives a signal from each of the sensors 12, 14 and determines an estimated position C₁ TP ESTIMATE of the throttle 30 of the engine 20 based upon the rate of rotation of the crank wheel 26 measured by the revolution sensor 14 and the pressure measured C₁ at the third rotational position of the crank wheel 26. The processor 16 employs the use of the instruction set 28 to estimate the position of the throttle 30 at the third rotational position of the crank wheel 26. The processor 16 calculates a delta estimated position of the throttle 30 value between the estimated position C₁ TP ESTIMATE of the throttle 30 at the third rotational position of the crank wheel 26 and the estimated position A₁ TP ESTIMATE of the throttle 30 at the first rotational position of the crank wheel 26. The processor 16 then calculates a delta pulse width value between a required pulse width based upon the delta estimated position of the throttle 30 value between the estimated position C₁ TP ESTIMATE and the estimated position A₁ TP ESTIMATE and the pre-dynamic pulse width determined from the delta pressure value between the pressure measured B₁ and the previous pressure measured at the second rotational position of the crank wheel 26 during the first cycle of the engine 20. The engine system 18 is controlled in response to the delta pulse width value. As shown, the delta pulse width value does not initiate a final dynamic pulse width.

The first sensor 12 measures a pressure A₂ in the manifold 22 of the engine 20 at the first rotational position of the crank wheel 26. As shown, the pressure measured A₂ is sampled at the first rotational position of the crank wheel 26 which is substantially instantaneous with the close of the intake valve at about 450° to about 500° of crank angle of the crank wheel 26 during the second cycle of the engine 20. Substantially simultaneously, the revolution sensor 14 measures a rate of rotation of the crank wheel 26. The processor 16 receives a signal from each of the sensors 12, 14 and determines an estimated position A₂ TP ESTIMATE of the throttle 30 of the engine 20 based upon the rate of rotation of the crank wheel 26 measured by the revolution sensor 14 and the pressure measured A₂ at the first rotational position of the crank wheel 26. The engine system 18 is controlled in response to the pressure measured kat the first rotational position of the crank wheel 26, whereby the pressure measured A₂ is used to initiate a base pulse width to deliver a steady state fuel requirement.

The first sensor 12 measures a pressure B₂ in the manifold 22 of the engine 20 at the second rotational position of the crank wheel 26. As shown, the pressure measured B₂ is sampled at the second rotational position of the crank wheel 26 prior to an opening of the intake valve at about 340° to about 380° of crank angle of the crank wheel 26 during a third cycle of the engine 20. The processor 16 receives a signal from the first sensor 12 and calculates a delta pressure value between the pressure measured B₂ at the second rotational position of the crank wheel 26 and the pressure measured B₁ at the second rotational position of the crank wheel 26 during the second cycle of the engine 20. The engine system 18 is controlled in response to the delta pressure value between the pressure measured B₂ at the second rotational position of the crank wheel 26 and the pressure measured B₁ at the second rotational position of the crank wheel 26. As shown, the delta pressure value did not recognize a transient throttle 30 event and a pre-dynamic pulse width was not initiated.

The first sensor 12 measures a pressure C₂ in the manifold 22 of the engine 20 at a third rotational position of the crank wheel 26. As shown, the pressure measured C₂ is sampled at the third rotational position of the crank wheel 26 during an opening of the intake valve at about 380° to about 420° of crank angle of the crank wheel 26 during the third cycle of the engine 20. Substantially simultaneously, the revolution sensor 14 measures a rate of rotation of the crank wheel 26. The processor 16 receives a signal from each of the sensors 12, 14 and determines an estimated position C₂ TP ESTIMATE of the throttle 30 of the engine 20 based upon at least one of the rotational position and the rate of rotation of the crank wheel 26 measured by the revolution sensor 14 and the pressure measured C₂ at the third rotational position of the crank wheel 26. The processor 16 employs the use of the instruction set 28 to estimate the position of the throttle 30 at the third rotational position of the crank wheel 26. The processor 16 calculates a delta estimated position of the throttle 30 value between the estimated position C₂ TP ESTIMATE of the throttle 30 at the third rotational position of the crank wheel 26 and the estimated position A₂ TP ESTIMATE of the throttle 30 at the first rotational position of the crank wheel 26. The processor 16 then calculates a delta pulse width value between a required pulse width based upon the delta estimated position of the throttle 30 value determined from the estimated position C₂ TP ESTIMATE and the estimated position A₂ TP ESTIMATE and the pre-dynamic pulse width determined from the delta pressure value between the pressure measured B₂ and the pressure measured B₁. The engine system 18 is controlled in response to the delta pulse width value. As shown, the delta pulse width value does not initiate a final dynamic pulse width.

The first sensor 12 measures a pressure A₃ in the manifold 22 of the engine 20 at the first rotational position of the crank wheel 26. As shown, the pressure measured A₃ is sampled at the first rotational position of the crank wheel 26 which is substantially instantaneous with the close of the intake valve at about 450° to about 500° of crank angle of the crank wheel 26 during the third cycle of the engine 20. Substantially simultaneously, the revolution sensor 14 measures a rate of rotation of the crank wheel 26. The processor 16 receives a signal from each of the sensors 12, 14 and determines an estimated position A₃ TP ESTIMATE of the throttle 30 of the engine 20 based upon the rate of rotation of the crank wheel 26 measured by the revolution sensor 14 and the pressure measured A₃ at the first rotational position of the crank wheel 26. The engine system 18 is controlled in response to the pressure measured A₃ at the first rotational position of the crank wheel 26, whereby the pressure measured A₃ is used to initiate a base pulse width to deliver a steady state fuel requirement.

The first sensor 12 measures a pressure B₃ in the manifold 22 of the engine 20 at the second rotational position of the crank wheel 26. As shown, the pressure measured B₃ is sampled at the second rotational position of the crank wheel 26 prior to an opening of the intake valve at about 340° to about 380° of crank angle of the crank wheel 26 during a fourth cycle of the engine 20. The processor 16 receives a signal from the first sensor 12 and calculates a delta pressure value between the pressure measured B₃ at the second rotational position of the crank wheel 26 and the pressure measured B₂ at the second rotational position of the crank wheel 26 during the third cycle of the engine 20. The engine system 18 is controlled in response to the delta pressure value between the pressure measured B₃ at the second rotational position of the crank wheel 26 and the pressure measured B₂ at the second rotational position of the crank wheel 26. As shown, the delta pressure value is used to recognize a transient throttle 30 event (i.e. the throttle 30 is opened) and a pre-dynamic pulse width was initiated to deliver a substantial amount of a fuel requirement.

The first sensor 12 measures a pressure C₃ in the manifold 22 of the engine 20 at a third rotational position of the crank wheel 26. As shown, the pressure measured C₃ is sampled at the third rotational position of the crank wheel 26 during an opening of the intake valve at about 380° to about 420° of crank angle of the crank wheel 26 during the fourth cycle of the engine 20. Substantially simultaneously, the revolution sensor 14 measures a rate of rotation of the crank wheel 26. The processor 16 receives a signal from each of the sensors 12, 14 and determines an estimated position C₃ TP ESTIMATE of the throttle 30 of the engine 20 based upon the rate of rotation of the crank wheel 26 measured by the revolution sensor 14 and the pressure measured C₃ at the third rotational position of the crank wheel 26. The processor 16 employs the use of the instruction set 28 to estimate the position of the throttle 30 at the third rotational position of the crank wheel 26. The processor 16 calculates a delta estimated position of the throttle 30 value between the estimated position C₃ TP ESTIMATE of the throttle 30 at the third rotational position of the crank wheel 26 and the estimated position A₃ TP ESTIMATE of the throttle 30 at the first rotational position of the crank wheel 26. The processor 16 then calculates a delta pulse width value between a required pulse width based upon the delta estimated position of the throttle 30 value determined from the estimated position C₃ TP ESTIMATE and the estimated position A₃ TP ESTIMATE and the pre-dynamic pulse width determined from the delta pressure value between the pressure measured B₃ and the pressure measured B₂. The engine system 18 is controlled in response to the delta pulse width value. As shown, the delta pulse width value initiates a final dynamic pulse width to deliver a remainder amount of the fuel requirement.

The control system 10 and the methods 200, 300 provide a means for controlling an engine system without the required use of a throttle position sensor. In certain embodiments, inferring or estimating a throttle position by using a manifold absolute pressure sensor, allows an elimination of a conventional throttle position sensor. Accordingly, the cost of the control system 10 is minimized.

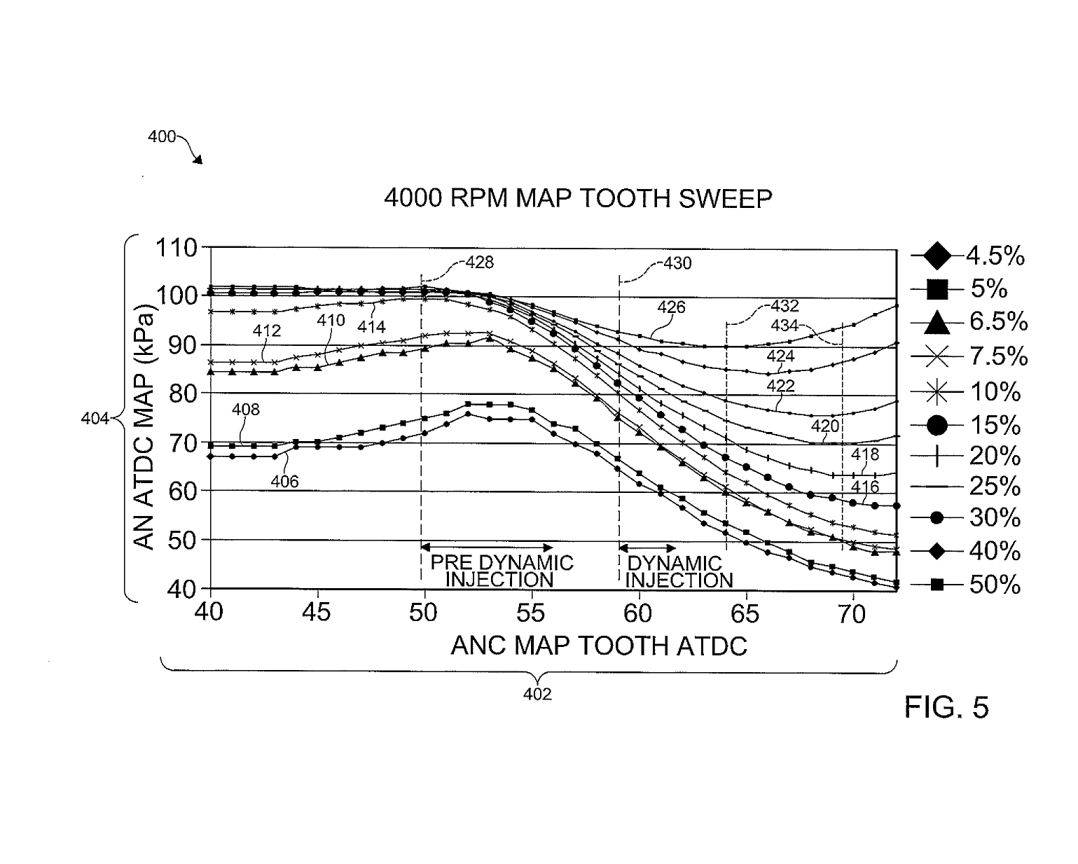

FIG. 5 is a graphical representation of a simulation of the operation of the engine 20. A simulated graph 400 of a conventional tooth sweep plot 402 (i.e. x-axis) representing a position of the crank wheel 26 (e.g. at 4000 RPM) and a measured manifold absolute pressure (MAP) 404 (i.e. y-axis) is plotted against the conventional tooth sweep plot 402. As shown, a plurality of plot lines 406, 408, 410, 412, 414, 416, 418, 420, 422, 424, 426 represent an opening position of the throttle 30 as 4.5%, 5%, 6.5%, 7.5%, 10%, 15%, 20%, 25%, 30%, 40%, and 50% respectively. A line marker 428 represents a position along the conventional tooth sweep plot 402 where step 318 is typically initiated. Favorable results have been achieved when a majority of a fuel is delivered into the manifold 22 after the position designated by the line marker 428. However, other positions can be used. A line marker 430 represents a position along the conventional tooth sweep plot 402 where step 328 is typically initiated. Favorable results have been achieved when a supplemental level of fuel is delivered into the manifold 22 after the position designated by the line marker 430. It is understood that by designating a supplemental fuel task later in an intake event a more accurate estimation of a position of the throttle 30 can be provided, resulting in a more accurate delivery of overall fuel. However, other positions can be used. A line marker 432 represents a position along the conventional tooth sweep plot 402 designating the last position where fuel can be injected into the manifold 22 in order to reach an associated cylinder (not shown). A line marker 434 represents a typical position along the conventional tooth sweep plot 402 where step 310 is executed in order to establish the first pressure measurement for used in the next fuel delivery cycle. However, other positions can be used.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A control system for an engine having at least one manifold, a throttle, and a crank wheel, the system comprising:
a pressure sensor to measure a pressure in the at least one manifold and generate a pressure signal representing the pressure measured;
a revolution sensor to measure a rate of rotation of the crank wheel of the engine and generate a rotation signal representing the rate of rotation measured;
a processor in communication with each of the pressure sensor and the revolution sensor to receive the pressure signal and the rotation signal, analyze the pressure signal and the rotation signal based upon an instruction set to estimate a position of the throttle, and generate a control signal in response to the analysis of the pressure signal and the rotation signal; and
an engine system in communication with the processor to receive the control signal therefrom, the engine system responsive to the control signal to control a function of the engine system.

2. The system according to claim 1, wherein the pressure sensor is an absolute pressure sensor.

3. The system according to claim 1, wherein the instruction set includes a formulaic means to estimate the position of the throttle based upon the pressure measured and the rate of rotation of the crank wheel measured.

4. The system according to claim 1, wherein the engine system controls a fuel injection into the at least one manifold in response to the control signal.

5. The system according to claim 1, wherein the engine system controls a fuel mass to air mass ratio that is injected into the at least one manifold in response to the control signal.

6. The system according to claim 1, wherein the engine system includes a fuel injector and controls an injection pulse rate of the fuel injector in response to the control signal.

7. The system according to claim 1, wherein the revolution sensor measures a rotational position of the crank wheel of the engine and the rotation signal also represents at least the rotational position measured.

8. A method for controlling an engine, the method comprising the steps of:
a) measuring a pressure in at least one manifold of the engine;
b) measuring a rate of rotation of a crank wheel of the engine;
c) determining an estimated position of a throttle of the engine based upon the pressure measured in the at least one manifold and the rate of rotation of the crank wheel measured; and
d) controlling an engine system based upon the estimated position of the throttle.

9. The method according to claim 8, wherein the pressure is measured using an absolute pressure sensor.

10. The method according to claim 8, wherein the step of controlling the engine system includes controlling a fuel injection into the at least one manifold.

11. The method according to claim 8, wherein the engine system includes a fuel injector and the step of controlling the engine system includes controlling an injection pulse rate of the fuel injector.

12. The method according to claim 8, wherein the step of controlling the engine system includes controlling a fuel mass to air mass ratio that is injected into the at least one manifold.

13. The method according to claim 8, further comprising the step of measuring a rotational position of the crank wheel, wherein the estimated position of the throttle is also determined based upon at least the rotational position of the crank wheel.

14. A method for controlling an engine, the method comprising the steps of:
a) measuring a first pressure in at least one manifold of the engine at a first rotational position of a crank wheel of the engine;
b) measuring a first pressure in the at least one manifold of the engine at a second rotational position of the crank wheel;
c) measuring a second pressure in the at least one manifold of the engine at the second rotational position of the crank wheel;
d) determining a delta pressure measured value between the second pressure measured at the second rotational position of the crank wheel and the first pressure measured at the second rotational position of the crank wheel; and
e) controlling the engine system based upon the delta pressure measured value.

15. The method according to claim 14, wherein the first rotational position of the crank wheel is at about 450° to about 500° of crank angle in respect of a top dead center position during a compression phase of a piston of the engine.

16. The method according to claim 14, wherein the second rotational position of the crank wheel is at about 340° to about 380° of crank angle in respect of a top dead center position during a compression phase of a piston of the engine.

17. The method according to claim 14, further comprising the step of measuring a rate of rotation of the crank wheel at the first rotational position of the crank wheel.

18. The method according to claim 17, further comprising the steps of:
f) measuring a first pressure in the at least one manifold of the engine at a third rotational position of the crank wheel of the engine;
g) measuring a rate of rotation of the crank wheel of the engine at the third rotational position of the crank wheel;
h) determining a first estimated position of a throttle of the engine based upon the first pressure measured at the first rotational position of the crank wheel and the rate of rotation of the crank wheel at the first rotational position;
i) determining a second estimated position of the throttle of the engine based upon the first pressure measured at the third rotational position of the crank wheel and the rate of rotation of the crank wheel at the third rotational position; and
j) determining a delta estimated position of the throttle value between the second estimated position of the throttle and the first estimated position of the throttle.

19. The method according to claim 18, wherein the third rotational position of the crank wheel is at about 380° to about 420° of crank angle in respect of a top dead center position during a compression phase of a piston of the engine.

20. The method according to claim 18, further comprising the steps of:
k) determining a delta pulse width value between a required pulse width based upon the delta estimated position of the throttle value and a pre-dynamic pulse width based upon the delta pressure measured value; and
l) controlling the engine system based upon the delta pulse width value.
